(19) United States
(12) Patent Application Publication
(10) Pub. No.: US 2023/0244385 A1
(43) Pub. Date: Aug. 3, 2023

(54) STORAGE APPARATUS AND CONTROL METHOD

(71) Applicant: Fujitsu Limited, Kawasaki-shi (JP)

(72) Inventor: Akiko SAKAGUCHI, Yokohama (JP)

(73) Assignee: Fujitsu Limited, Kawasaki-shi (JP)

(21) Appl. No.: 18/055,079

(22) Filed: Nov. 14, 2022

(30) Foreign Application Priority Data
Jan. 28, 2022 (JP) 2022-011461

(51) Int. Cl. G06F 3/06

(52) U.S. Cl. CPC G06F 3/0617; G06F 3/0689; G06F 3/0659

(57) ABSTRACT

A processor is configured to, when writing of first data for a first storage device is requested during update of firmware of the first storage device, write the first data for a second storage device, and register a write destination address of the first data in management information in association with the first data, and when reading of second data from the first storage device is requested during the update of the firmware, refer to the management information, read the second data from the second storage device in a case where a read source address of the second data is registered in the management information, and acquire the second data based on data stored in another storage device other than the first storage device in a case where the read source address of the second data is not registered in the management information.

### CROSS-REFERENCE TO RELATED APPLICATION

This application is based upon and claims the benefit of priority of the prior Japanese Patent Application No. 2022-11461, filed on Jan. 28, 2022, the entire contents of which are incorporated herein by reference.

### FIELD

The embodiments discussed herein are related to a storage apparatus and a control method.

### BACKGROUND

A storage apparatus includes, for example, a plurality of storage devices and a control device that controls input/output (I/O) processing for each storage device. The control device is commonly loaded with firmware for executing various types of processing such as the control of the I/O processing. Furthermore, each storage device is also loaded with firmware for operating each storage device.

Here, the following technology has been proposed for updating firmware in a storage apparatus. For example, there is proposed a storage apparatus in which, among blades that operate as storage control devices, a service provided by a blade whose firmware is to be updated is moved to another blade in a cluster, and firmware of the blade which is in a non-service providing state is updated.

Furthermore, there is also proposed the following storage apparatus including a statistical processing program. In this storage apparatus, first definition information is updated in a case where definition information is updated together with update of the statistical processing program, and second definition information is updated in a case where the definition information is updated without updating the statistical processing program. Then, by using the updated first or second definition information, statistical processing for controlling the storage apparatus is performed.

Japanese Laid-open Patent Publication No. 2006-31312 and Japanese Laid-open Patent Publication No. 2015-184925 are disclosed as related art.

### SUMMARY

According to an aspect of the embodiments, a storage apparatus includes a memory, and a processor coupled to the memory and configured to, when writing of first data for a first storage device among two or more storage devices included in a redundant array of inexpensive disks (RAID) group among a plurality of storage devices is requested during update of firmware of the first storage device, execute first write processing of writing the first data for a second storage device other than the two or more storage devices among the plurality of storage devices, and registering a write destination address of the first data in management information as a save source address in association with the first data, and, when reading of second data from the first storage device is requested during the update of the firmware, execute first read processing of referring to the management information, reading the second data from the second storage device in a case where a read source address of the second data in the first storage device is registered in the management information as the save source address, based on a result of the referring, and acquiring the second data based on data stored in another storage device other than the first storage device among the two or more storage devices in a case where the read source address of the second data is not registered in the management information as the save source address, based on the result of the referring.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example and a processing example of a storage system according to a first embodiment;

FIG. 2 is a diagram illustrating a configuration example of a storage system according to a second embodiment;

FIG. 3 is a diagram illustrating a hardware configuration example of a controller module (CM) and a drive enclosure (DE);

FIG. 4 is a diagram illustrating a configuration example of processing functions of the CM;

FIG. 5 is a diagram illustrating a data configuration example of a disk use state management table;

FIG. 6 is a diagram illustrating a data configuration example of a redundant array of inexpensive disks (RAID) group management table;

FIG. 7 is a time chart illustrating a comparative example of firmware update processing of a disk drive;

FIG. 8 is an example of a flowchart illustrating an overall procedure of the firmware update processing in the second embodiment;

FIG. 9 is a diagram illustrating a data configuration example of an update order management table;

FIG. 10 is an example of a flowchart illustrating a procedure of the firmware update processing for an unused disk;

FIG. 11 is an example of a flowchart illustrating a procedure of the firmware update processing for a disk drive of a disk cache;

FIG. 12 is an example of a flowchart illustrating a procedure of the firmware update processing for a spare disk;

FIG. 13 is a diagram for describing processing at a start of first update processing;

FIG. 14 is a diagram for describing write processing during the first update processing;

FIGS. 15A and 15B are diagrams for describing read processing during the first update processing;

FIG. 16 is a diagram for describing writeback processing executed after the first update processing;

FIG. 17 is a diagram for describing second update processing;

FIG. 18 is an example of a flowchart illustrating a procedure of the firmware update processing for a RAID data disk;

FIG. 19 is an example of a flowchart illustrating a procedure of the first update processing;

FIG. 20 is an example of a flowchart illustrating a procedure of the write processing during the first update processing;

FIG. 21 is an example of a flowchart illustrating a procedure of the read processing during the first update processing;

FIG. 22 is an example of a flowchart illustrating a procedure of the writeback processing from a save destination disk to a disk to be updated;

FIG. 23 is an example of a flowchart illustrating a procedure of the second update processing;

FIG. 24 is an example of a flowchart illustrating a procedure of rebuild processing of data for a spare disk incorporated into a RAID group;

FIG. 25 is an example of a flowchart illustrating a procedure of the writeback processing from a spare disk to a disk to be updated;

FIG. 26 is an example of a flowchart illustrating a procedure of the write processing during the rebuild processing; and

FIG. 27 is an example of a flowchart illustrating a procedure of the read processing during the rebuild processing.

### DESCRIPTION OF EMBODIMENTS

When firmware of a storage device in a storage apparatus is updated, I/O processing for the storage device is suppressed. For example, when a time needed for updating the firmware is shorter than a timeout time in a host device requesting the storage apparatus to access the storage device, the I/O processing from the host device to the storage apparatus may be continued without causing any particular problem.

Recently, however, capacity of the firmware of the storage device tends to increase, and the time needed for updating the firmware may become longer than the timeout time described above. In that case, the I/O processing from the host device to the storage apparatus stops.

Hereinafter, embodiments of techniques capable of continuing I/O processing for the storage apparatus even during firmware update of a storage device will be described with reference to the drawings.

### First Embodiment

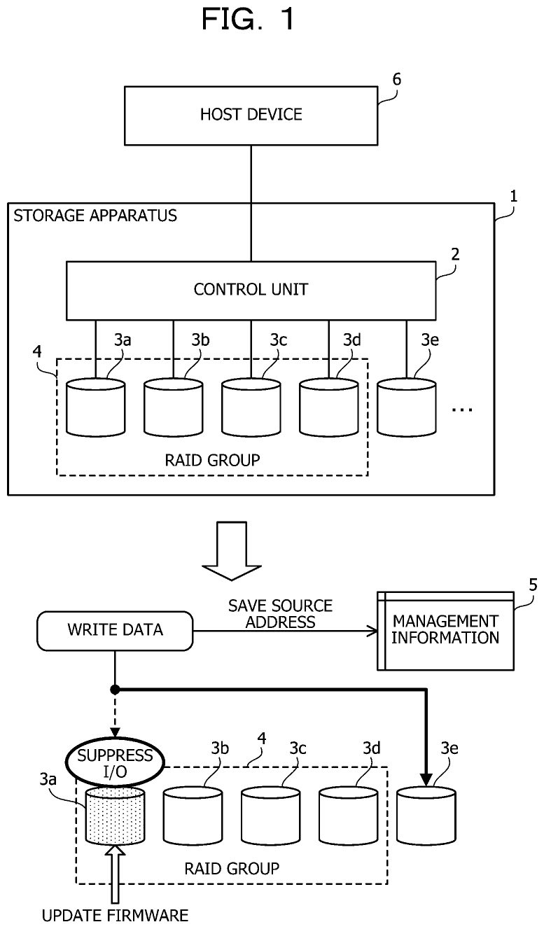

FIG. 1 is a diagram illustrating a configuration example and a processing example of a storage system according to a first embodiment. The storage system illustrated in FIG. 1 includes a storage apparatus 1 and a host device 6. Furthermore, the storage apparatus 1 includes a control unit 2 and storage devices 3a, 3b, 3c, 3d, 3e, . . . .

The control unit 2 is, for example, a processor. Furthermore, the control unit 2 may be a storage control device including a processor. The control unit 2 controls access to the storage devices 3a, 3b, 3c, 3d, 3e, . . . in response to an input/output (I/O) request from the host device 6.

Each of the storage devices 3a, 3b, 3c, 3d, 3e, . . . is a nonvolatile storage device such as a hard disk drive (HDD) or a solid state drive (SSD), for example. The storage devices 3a, 3b, 3c, 3d, 3e, . . . read and write data according to firmware. Furthermore, in the example of FIG. 1, the storage devices 3a to 3d are disks included in a redundant array of inexpensive disks (RAID) group 4. For example, the control unit 2 controls I/O processing for the storage devices 3a to 3d by RAID.

The host device 6 is, for example, a computer that executes predetermined processing related to a business or the like by using storage areas of the storage devices 3a, 3b, 3c, 3d, 3e, . . . .

Next, processing in a case where the firmware of the storage device 3a is updated among the storage devices 3a to 3d included in the RAID group 4 will be described as an example. When the firmware of the storage device 3a is updated, the control unit 2 suppresses the I/O processing for the storage device 3a, and applies update firmware to the storage device 3a in this state.

Furthermore, during the update of the firmware of the storage device 3a, the I/O processing for the storage device 3a may be requested in response to the I/O request from the host device 6. In this case, the following processing is executed.

In a case where data writing to the storage device 3a is requested, as illustrated in a lower part of FIG. 1, the control unit 2 writes data requested to be written (write data) to the another storage device 3e not included in the RAID group 4. At the same time, the control unit 2 registers a write destination address of the write data in the storage device 3a in management information 5 as a save source address in association with the write data. In the management information 5, for example, the save source address and a write destination address of the write data in the storage device 3e serving as a save destination are registered in association with each other.

Furthermore, in a case where data reading from the storage device 3a is requested, the control unit 2 refers to the management information 5 and determines whether a read source address of data requested to be read (read data) in the storage device 3a is registered as the save source address. In a case where the read source address is registered as the save source address, the read data is saved in the storage device 3e. Thus, the control unit 2 reads the read data from the storage device 3e serving as the save destination.

On the other hand, in a case where the read source address is not registered as the save source address, the control unit 2 acquires the read data on the basis of data stored in the storage devices 3b to 3d other than the storage device 3a in the RAID group 4. For example, in a case where a RAID level of the RAID group 4 is “1+0”, the control unit 2 reads the read data from one of the storage devices 3b to 3d in which the data of the storage device 3a is mirrored. Furthermore, for example, in a case where the RAID level of the RAID group 4 is “5”, the control unit 2 restores the read data by using divided data and parity read from the storage devices 3b to 3d.

According to the processing of the control unit 2 as described above, the I/O processing for the storage apparatus 1 in response to the I/O request from the host device 6 may be continued even during the update of the firmware of the storage device 3a. Thus, even in a case where capacity of the firmware of the storage device 3a is large and an update time of the firmware is long, it is possible to avoid occurrence of a situation where a timeout occurs for the I/O request from the host device 6.

### Second Embodiment

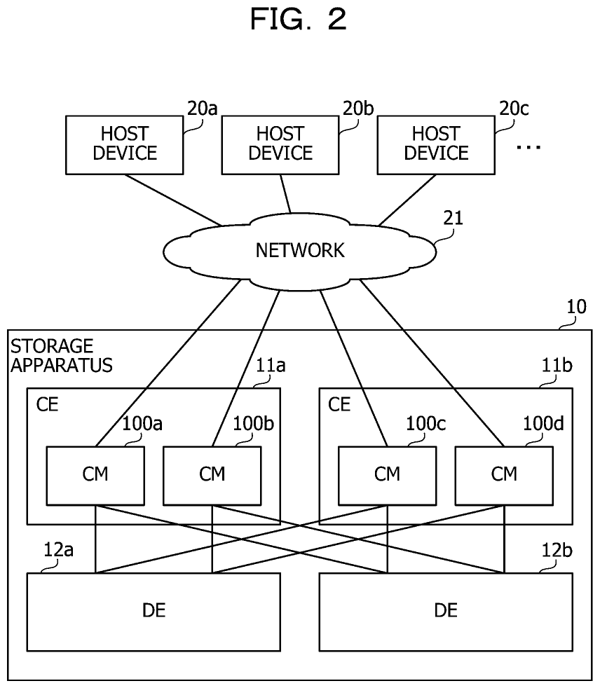

FIG. 2 is a diagram illustrating a configuration example of a storage system according to a second embodiment. The storage system illustrated in FIG. 2 includes a storage apparatus 10 and host devices 20a, 20b, 20c, . . . .

The storage apparatus 10 includes controller enclosures (CEs) 11a and 11b and drive enclosures (DEs) 12a and 12b. The CE 11a is loaded with controller modules (CMs) 100a and 100b. The CE 11b is loaded with CMs 100c and 100d.

The CMs 100a to 100d are connected to the host devices 20a, 20b, 20c, . . . via a network 21. The network 21 is, for example, a storage area network (SAN) using a fibre channel (FC), an Internet small computer system interface (iSCSI), or the like. The CMs 100a to 100d are storage control devices that access storage devices loaded in the DEs 12a and 12b in response to requests from the host devices 20a, 20b, 20c, . . . .

Each of the DEs 12a and 12b is loaded with a plurality of storage devices to be accessed from the CMs 100a to 100d. As these storage devices, nonvolatile storage devices such as HDDs and SSDs are loaded. Hereinafter, these nonvolatile storage devices are referred to as “disk drives”.

The host devices 20a, 20b, 20c, . . . are computers that execute processing related to various businesses by using storage areas of the storage apparatus 10.

Note that, in the following description, in a case where the CEs 11a and 11b are indicated without particular distinction, the CEs 11a and 11b may be referred to as “CE 11”. Furthermore, in a case where the host devices 20a, 20b, 20c, . . . are indicated without particular distinction, the host devices 20a, 20b, 20c, . . . may be referred to as “host device 20”. Moreover, in a case where the CMs 100a to 100d are indicated without particular distinction, the CMs 100a to 100d may be referred to as “CM 100”. Furthermore, in a case where the DEs 12a and 12b are indicated without particular distinction, the DEs 12a and 12b may be referred to as “DE 12”.

In the storage apparatus 10 described above, a logical volume (logical storage area) to be accessed from the host device 20 is set. The CM 100 controls access to the logical volume in response to a request from the host device 20. Furthermore, the logical volume is implemented by a physical storage area of one or more disk drives. For example, the logical volume is implemented by a plurality of disk drives managed by RAID.

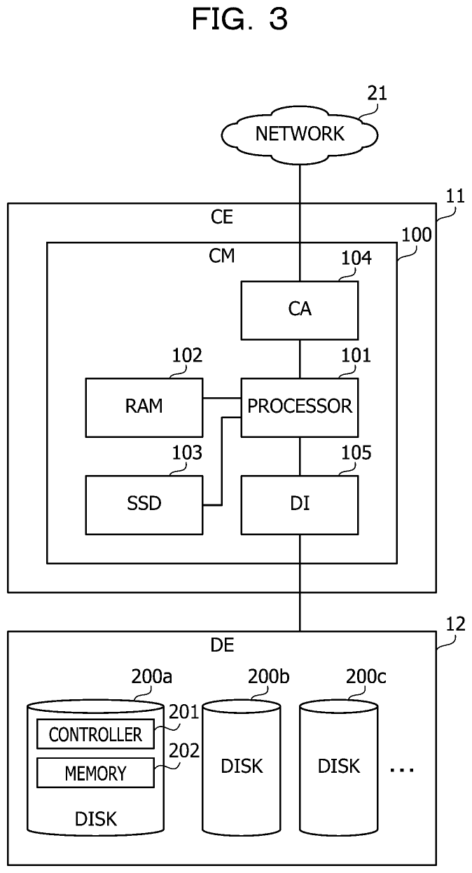

FIG. 3 is a diagram illustrating a hardware configuration example of the CM and the DE. The CM 100 includes a processor 101, a random access memory (RAM) 102, an SSD 103, a channel adapter (CA) 104, and a drive interface (DI) 105.

The processor 101 integrally controls the entire CM 100. The processor 101 is any one of, for example, a central processing unit (CPU), a micro processing unit (MPU), a digital signal processor (DSP), an application specific integrated circuit (ASIC), a graphics processing unit (GPU), and a programmable logic device (PLD). Furthermore, the processor 101 may be a combination of two or more elements among the CPU, MPU, DSP, ASIC, GPU, and PLD.

The RAM 102 is a main storage device of the CM 100. The RAM 102 temporarily stores at least a part of an operating system (OS) program or an application program to be executed by the processor 101. Furthermore, the RAM 102 stores various types of data used for processing by the processor 101.

The SSD 103 is an auxiliary storage device of the CM 100. The SSD 103 stores an OS program, an application program, and various types of data. Note that the CM 100 may include an HDD instead of the SSD 103 as an auxiliary storage device.

The CA 104 is an interface for communicating with the host device 20 via the network 21. The DI 105 is an interface for communicating with the disk drives in the DE 12.

As described above, the DE 12 includes disk drives (DISKs) 200a, 200b, 200c, . . . to be accessed from the CM 100. Each of the disk drives 200a, 200b, 200c, . . . includes a controller 201 and a nonvolatile memory 202 in addition to a data storage unit (not illustrated) such as a disk unit of an HDD or a memory cell unit of an SSD. The memory 202 stores firmware and various types of data. The controller 201 is, for example, a control circuit including a processor, and controls reading and writing of data to and from the data storage unit according to firmware in the memory 202.

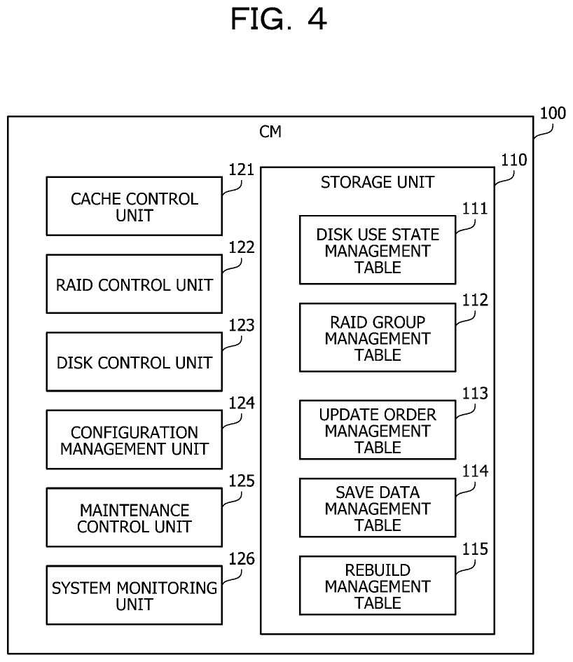

FIG. 4 is a diagram illustrating a configuration example of processing functions of the CM. The CM 100 includes a storage unit 110, a cache control unit 121, a RAID control unit 122, a disk control unit 123, a configuration management unit 124, a maintenance control unit 125, and a system monitoring unit 126.

The storage unit 110 is a storage area of a storage device included in the CM 100, such as the RAM 102 or the SSD 103. The storage unit 110 stores a disk use state management table 111, a RAID group management table 112, an update order management table 113, a save data management table 114, and a rebuild management table 115.

In the disk use state management table 111, information related to all the disk drives loaded in the DEs 12a and 12b is registered. In the RAID group management table 112, information related to RAID groups is registered.

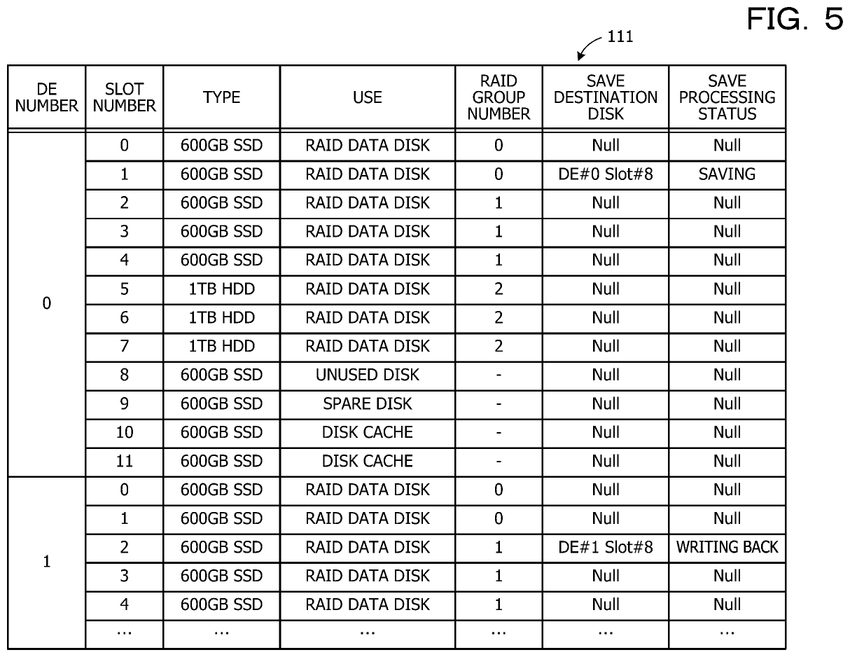

Here, FIG. 5 is a diagram illustrating a data configuration example of the disk use state management table. In the disk use state management table 111, records corresponding to the respective disk drives loaded in the DEs 12a and 12b are registered. In the present embodiment, the disk drive is identified by a DE number indicating the DE 12 in which the disk drive is loaded and a slot number indicating a slot in which the disk drive is mounted in the DE 12. Note that, in the following description, a disk drive loaded in a slot with the slot number “Y” in the DE 12 with the DE number “X” is referred to as “disk drive with the DE #X and the slot #Y”.

Each record includes a type, use, a RAID group number, a save destination disk, and a save processing status. In an item of the type, storage capacity of a disk drive and information indicating whether the disk drive is an HDD or an SSD are registered. For example, in FIG. 5, it is registered that the type of a disk drive with the DE #0 and the slot #0 is an SSD having the storage capacity of 600 gigabyte (GB).

In an item of the use, information indicating what kind of use a disk drive is used for is registered. The information registered in the item of the use includes a RAID data disk, a spare disk, a disk cache, and an unused disk. The RAID data disk indicates a disk drive included in a RAID group. The spare disk indicates a disk drive that is used in a case where a RAID data disk is failed, instead of the RAID data disk. The disk cache indicates that a disk drive is used as a part of a cache area. The unused disk indicates that a disk drive is not being used for any use.

The RAID group number indicates an identification number of a RAID group including a disk drive in a case where the disk drive is a RAID data disk.

Each of items of the save destination disk and the save processing status is used in a case where “first update processing”, which will be described later, is executed in firmware update of a RAID data disk. In the item of the save destination disk, in a case where a save destination disk used as a save destination of write data is set, an identification number of the save destination disk is registered. In the item of the save processing status, in a case where a save destination disk is set, information indicating whether a current operation state is “saving” or “writing back” is registered. The “saving” indicates that write data is in a state of being saved, and the “writing back” indicates that saved data is in a state of being written back to an original disk drive.

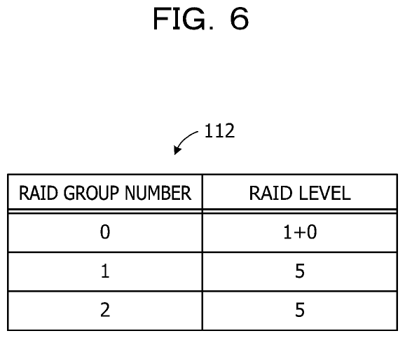

FIG. 6 is a diagram illustrating a data configuration example of the RAID group management table. In the RAID group management table 112, a record corresponding to each set RAID group is registered. In each record, a RAID group number that identifies a RAID group and a RAID level that is set for the RAID group are registered.

Hereinafter, the description will be continued with reference to FIG. 4. The update order management table 113, the save data management table 114, and the rebuild management table 115 are management information temporarily stored at the time of firmware update of a disk drive.

In the update order management table 113, identification information of a disk drive whose firmware is to be updated (disk to be updated) is classified according to the use registered in the disk use state management table 111 and registered.

The save data management table 114 is the management information that is referred to when the “first update processing” described later is executed. In the save data management table 114, a write destination address in a disk to be updated for each piece of data written to a save destination disk is registered.

The rebuild management table 115 is the management information that is created when “second update processing” described later is executed. The rebuild management table 115 is created as a bitmap having a bit corresponding to each unit storage area in a disk to be updated, and manages whether or not rebuilding of data of a unit storage area corresponding to each bit has been executed.

Processing of the cache control unit 121, the RAID control unit 122, the disk control unit 123, the configuration management unit 124, the maintenance control unit 125, and the system monitoring unit 126 is implemented by the processor 101 included in the CM 100 executing a predetermined program.

The cache control unit 121 executes, when receiving an I/O request for a logical volume from the host device 20, I/O processing for the logical volume in response to the I/O request by using a cache area. Examples of the cache area include a primary cache secured in the RAM 102, a secondary cache secured in the SSD 103, and a tertiary cache secured in a disk drive (cache disk) in the DE 12.

For example, when receiving a data read request from a certain logical volume, the cache control unit 121 determines whether data requested to be read (read data) is stored in the cache area. In a case where the read data is stored in the cache area, the cache control unit 121 reads the read data from the cache area, and transmits the read data to the host device 20. On the other hand, in a case where the read data is not stored in the cache area, the cache control unit 121 acquires the read data from the DE 12 via the RAID control unit 122. The cache control unit 121 transmits the acquired read data to the host device 20, and stores the acquired read data in the cache area.

Furthermore, when receiving a data write request for a certain logical volume, the cache control unit 121 stores data requested to be written in the cache area. Moreover, the cache control unit 121 writes (writes back) the data stored in the cache area to the disk drive of the DE 12 via the RAID control unit 122 at a timing asynchronous with a storage timing of the data. The disk drive serving as a write destination is a disk drive (RAID data disk) included in a RAID group associated with the logical volume to which the data is written.

The RAID control unit 122 accesses a disk drive that implements a physical storage area of a logical volume in response to a request from the cache control unit 121. The RAID control unit 122 controls access to such a disk drive by RAID.

The disk control unit 123 is a disk driver that controls data transmission and reception to and from a disk drive. For example, access to a disk drive by the RAID control unit 122 is performed via the disk control unit 123. Furthermore, the disk control unit 123 measures an amount of write data per unit time for each disk drive.

The configuration management unit 124 executes setting processing related to various configurations according to an instruction from an administrator terminal (not illustrated) operated by an administrator. For example, the configuration management unit 124 registers information related to a configuration of a RAID group in the disk use state management table 111 and the RAID group management table 112.

The maintenance control unit 125 executes processing related to maintenance of the storage apparatus 10. In the present embodiment, the maintenance control unit 125 executes firmware update control processing in each disk drive as an example of such processing.

The system monitoring unit 126 monitors an operation state of each unit in the storage apparatus 10. For example, the system monitoring unit 126 monitors each disk drive in the DE 12 to see whether an abnormality has occurred.

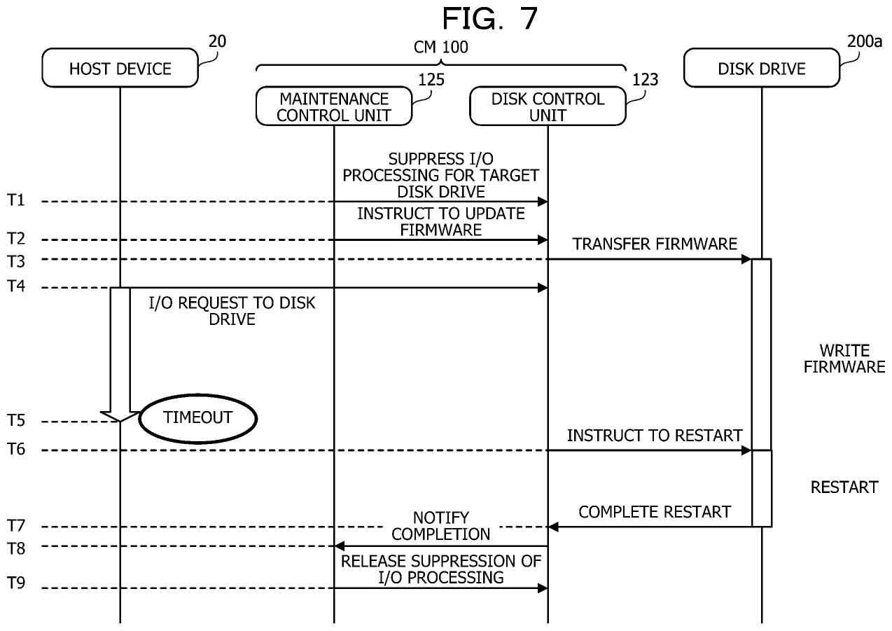

Next, a problem in firmware update of a disk drive will be described with reference to FIG. 7. FIG. 7 is a time chart illustrating a comparative example of firmware update processing of a disk drive. FIG. 7 illustrates the comparative example in a case where the firmware of the disk drive 200a is updated.

In this case, the maintenance control unit 125 first instructs the disk control unit 123 to suppress I/O processing for the disk drive 200a (time T1). Then, the maintenance control unit 125 instructs the disk control unit 123 to update the firmware of the disk drive 200a (time T2). The disk control unit 123 transfers update firmware to the disk drive 200a in response to the update instruction, and writes the update firmware to the memory 202 of the disk drive 200a (time T3). With this configuration, the update firmware is stored in the memory 202 of the disk drive 200a.

Thereafter, when writing of the update firmware is completed at a time T6, the disk control unit 123 instructs the disk drive 200a to restart. When the disk drive 200a is restarted in response to this instruction, the update firmware stored in the memory 202 is applied. For example, the update firmware is executed by the controller 201, and processing according to the update firmware is started.

When the restart is completed at a time T7, the disk control unit 123 notifies the maintenance control unit 125 that the firmware update is completed (time T8). The maintenance control unit 125 instructs the disk control unit 123 to release the suppression of the I/O processing for the disk drive 200a (time T9). With this configuration, the state where the I/O processing for the disk drive 200a may be performed is restored.

In the processing described above, the firmware of the disk drive 200a is updated in a state where the I/O processing for the disk drive 200a is suppressed. The suppression of the I/O processing may be released within a time not determined as a timeout by an OS or application of the host device 20 requesting the I/O processing. With this configuration, it is possible to execute the firmware update without affecting use of the storage apparatus 10 by the host device 20.

However, in recent years, capacity of firmware of a disk drive tends to increase, and there have been many cases where a firmware update processing time becomes longer than a time determined as a timeout. For example, in FIG. 7, the I/O processing for the disk drive 200a is requested at a time T4. However, since the I/O processing is suppressed, an execution standby state of the I/O processing occurs. However, at a time T5 before the suppression of the I/O processing is released, a timeout for the I/O request occurs.

In this way, when the suppression of the I/O processing is not released before it is determined that a timeout has occurred, the host device 20 determines that an abnormality has occurred in the storage apparatus 10, and executes various types of troubleshooting processing. Furthermore, in order not to cause a timeout, a method of suppressing the I/O request from the host device 20 in a period during the firmware update processing is conceivable. However, this method has a problem that a system on a side of the host device 20 is stopped, and a business using the host device 20 is stopped.

Therefore, in the present embodiment, the maintenance control unit 125 performs control so that firmware update processing of a disk to be updated is executed while continuing the I/O processing by using an unused disk or a spare disk. Furthermore, such control is needed only for a RAID data disk. Therefore, the maintenance control unit 125 selects and applies an appropriate firmware update procedure according to use of a disk drive.

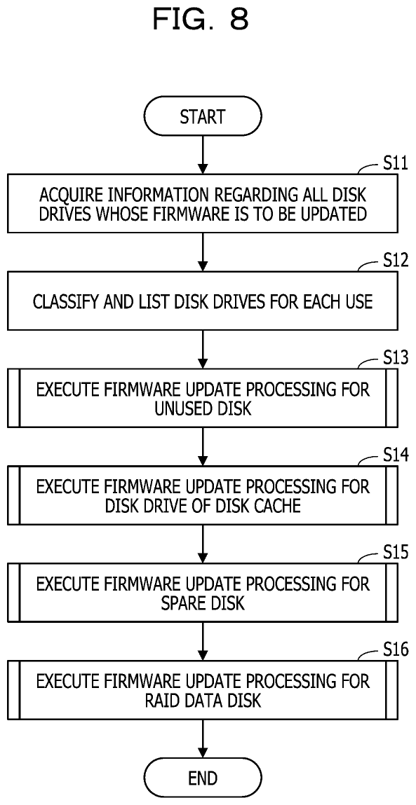

FIG. 8 is an example of a flowchart illustrating an overall procedure of the firmware update processing in the second embodiment. The firmware update of the disk drives included in the DEs 12a and 12b may be shared and executed by a plurality of CMs among the CMs 100a to 100d, or may be executed by only one CM. In the former case, a disk drive to be updated is allocated for each CM. FIG. 8 illustrates a procedure of the firmware update processing by one CM.

[Operation S11] The maintenance control unit 125 acquires, from the disk use state management table 111, information regarding all disk drives whose firmware is to be updated. For example, the type, use, and RAID group number of each disk drive are acquired from the disk use state management table 111.

[Operation S12] The maintenance control unit 125 classifies and lists the disk drives whose firmware is to be updated for each use. In this processing, the update order management table 113 is created, and identification information of the disk drives is classified and registered for each use in the created update order management table 113.

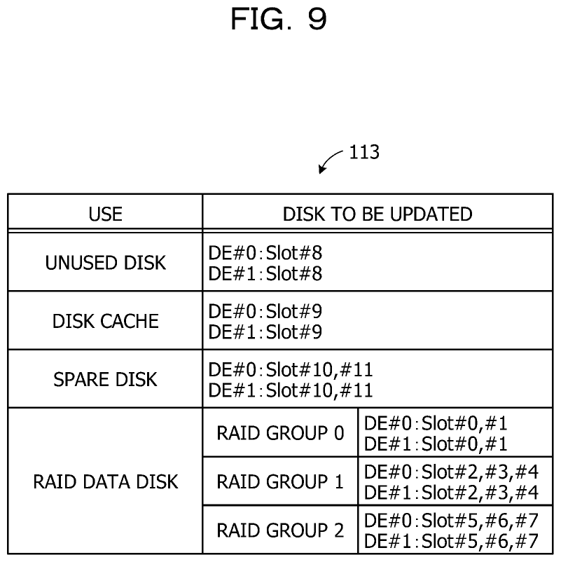

Here, FIG. 9 is a diagram illustrating a data configuration example of the update order management table. As illustrated in FIG. 9, in the update order management table 113, identification numbers of the disks to be updated are classified and registered for each use of an unused disk, a disk cache, a spare disk, and a RAID data disk. Furthermore, as will be described later, since firmware update is executed in units of RAID groups for the RAID data disks, the identification numbers of the disks to be updated for the RAID data disks are classified and registered for each RAID group.

In the example of FIG. 9, update order is determined so that firmware update is executed in order of the unused disk, the disk cache, the spare disk, and the RAID data disk from a top side of the update order management table 113. Note that the update order for each use is not limited to this example.

Hereinafter, the description will be continued with reference to FIG. 8.

[Operation S13] The firmware update processing for each unused disk registered in the update order management table 113 is executed.

[Operation S14] The firmware update processing for each disk drive of the disk cache registered in the update order management table 113 is executed.

[Operation S15] The firmware update processing for each spare disk registered in the update order management table 113 is executed.

[Operation S16] The firmware update processing for each RAID data disk registered in the update order management table 113 is executed.

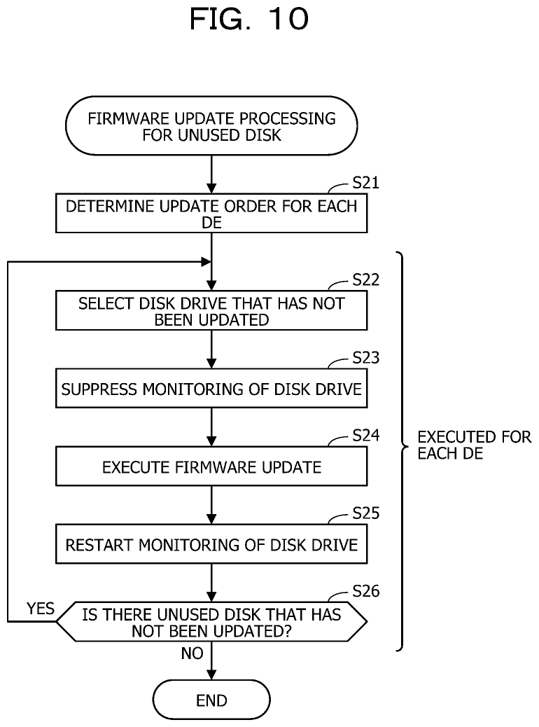

FIG. 10 is an example of a flowchart illustrating a procedure of the firmware update processing for an unused disk. The processing in FIG. 10 corresponds to the processing in Operation S13 in FIG. 8.

[Operation S21] The maintenance control unit 125 classifies unused disks registered in the update order management table 113 for each DE 12, and determines firmware update order for the unused disks included in the DE 12 for each DE 12.

Processing of the subsequent Operations S22 to S26 is executed for each DE 12. Furthermore, the processing in Operations S22 to S26 for each DE 12 may be executed in parallel.

[Operation S22] The maintenance control unit 125 selects an unused disk with the earliest update order from unused disks whose firmware have not been updated among the unused disks included in the DE 12 to be processed.

[Operation S23] The maintenance control unit 125 requests the system monitoring unit 126 to suppress monitoring of an operation state of the selected unused disk. Since I/O operation of a disk drive stops during the firmware update, when the system monitoring unit 126 continues to monitor the operation state of this disk drive, it is erroneously determined that an abnormality has occurred. By the processing in Operation S23, monitoring of the operation state of the selected unused disk is suppressed, so that occurrence of such erroneous determination may be prevented.

[Operation S24] The firmware update of the selected unused disk is executed. In this processing, the maintenance control unit 125 transfers update firmware to the corresponding unused disk via the disk control unit 123, and writes the update firmware to the memory 202 of the corresponding unused disk. When the writing ends, the corresponding unused disk is restarted according to an instruction from the disk control unit 123, and the update firmware is applied. When the above processing is completed, processing in the next Operation S25 is executed.

[Operation S25] The maintenance control unit 125 requests the system monitoring unit 126 to release the suppression of monitoring of the operation state of the selected unused disk. With this configuration, monitoring of the operation state by the system monitoring unit 126 is restarted.

[Operation S26] The maintenance control unit 125 determines whether there is an unused disk whose firmware has not been updated among the unused disks included in the DE 12 to be processed. In a case where there is a corresponding unused disk, the processing proceeds to Operation S22, and an unused disk with the earliest update order is selected from the corresponding unused disks. On the other hand, in a case where there is no corresponding unused disk, the firmware update processing for the unused disk ends.

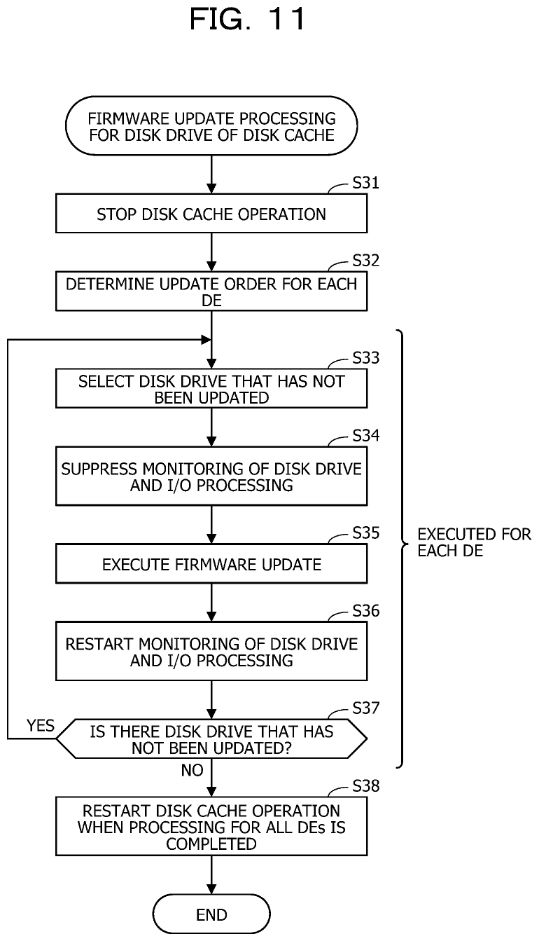

FIG. 11 is an example of a flowchart illustrating a procedure of the firmware update processing for a disk drive of a disk cache. The processing in FIG. 11 corresponds to the processing in Operation S14 in FIG. 8.

[Operation S31] The maintenance control unit 125 requests the cache control unit 121 to stop disk cache operation. In response to this request, the cache control unit 121 stops using a cache area during I/O processing, and executes the I/O processing in a write-through method.

[Operation S32] The maintenance control unit 125 classifies disk drives of disk caches registered in the update order management table 113 for each DE 12, and determines firmware update order for the corresponding disk drives included in the DE 12 for each DE 12.

Processing of the subsequent Operations S33 to S37 is executed for each DE 12. Furthermore, the processing in Operations S33 to S37 for each DE 12 may be executed in parallel.

[Operation S33] The maintenance control unit 125 selects a disk drive with the earliest update order from disk drives whose firmware have not been updated among the disk drives of the disk caches included in the DE 12 to be processed.

[Operation S34] The maintenance control unit 125 requests the system monitoring unit 126 to suppress monitoring of an operation state of the selected disk drive. With this configuration, monitoring of the operation state of the selected disk drive is suppressed. Furthermore, the maintenance control unit 125 requests the disk control unit 123 to suppress I/O processing for the selected disk drive. With this configuration, the I/O processing for the selected disk drive is suppressed.

[Operation S35] The firmware update of the selected disk drive is executed. In this processing, the maintenance control unit 125 transfers update firmware to the corresponding disk drive via the disk control unit 123, and writes the update firmware to the memory 202 of the corresponding disk drive. When the writing ends, the corresponding disk drive is restarted according to an instruction from the disk control unit 123, and the update firmware is applied. When the above processing is completed, processing in the next Operation S36 is executed.

[Operation S36] The maintenance control unit 125 requests the system monitoring unit 126 to release the suppression of monitoring of the operation state of the selected disk drive. With this configuration, monitoring of the operation state by the system monitoring unit 126 is restarted. Furthermore, the maintenance control unit 125 requests the disk control unit 123 to release the suppression of the I/O processing for the selected disk drive. With this configuration, the state where the I/O processing for the selected disk drive may be performed is restored.

[Operation S37] The maintenance control unit 125 determines whether there is a disk drive whose firmware has not been updated among the disk drives of the disk caches included in the DE 12 to be processed. In a case where there is a corresponding disk drive, the processing proceeds to Operation S33, and a disk drive with the earliest update order is selected from the corresponding disk drives. On the other hand, in a case where there is no corresponding disk drive, the processing proceeds to Operation S38.

[Operation S38] The maintenance control unit 125 stands by until the processing in Operations S33 to S37 is executed for all the DEs 12. Then, when the processing for all the DEs 12 is completed, the maintenance control unit 125 requests the cache control unit 121 to restart the disk cache operation. In response to this request, the cache control unit 121 restarts using the cache area during the I/O processing, and executes the I/O processing in a write-back method.

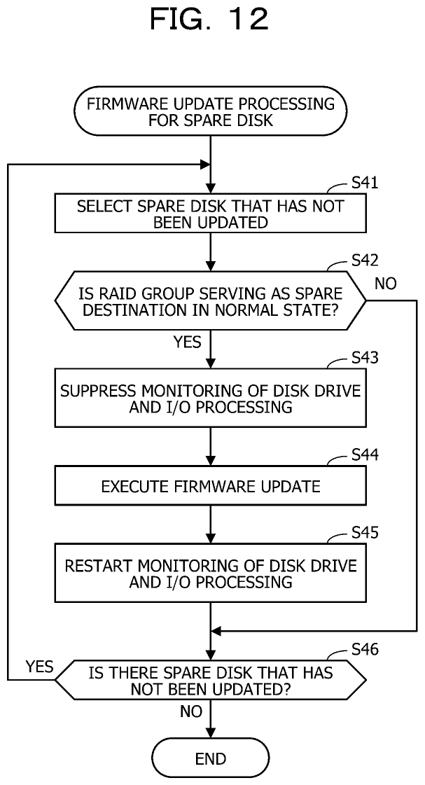

FIG. 12 is an example of a flowchart illustrating a procedure of the firmware update processing for a spare disk. The processing in FIG. 12 corresponds to the processing in Operation S15 in FIG. 8.

[Operation S41] The maintenance control unit 125 selects a spare disk whose firmware has not been updated from spare disks registered in the update order management table 113.

[Operation S42] The maintenance control unit 125 specifies a RAID group in which the selected spare disk serves as a spare destination (is used as a spare), and determines whether RAID data disks included in the RAID group are in a normal state. In a case where all the RAID data disks are in the normal state, the processing proceeds to Operation S43. On the other hand, in a case where there is one or more RAID data disks in an abnormal state, the selected spare disk may be incorporated into the RAID group. Thus, the processing proceeds to Operation S46, and execution of the firmware update for this spare disk is skipped.

[Operation S43] The maintenance control unit 125 requests the system monitoring unit 126 to suppress monitoring of an operation state of the selected spare disk. With this configuration, monitoring of the operation state of the selected spare disk is suppressed. Furthermore, the maintenance control unit 125 requests the disk control unit 123 to suppress I/O processing for the selected spare disk. With this configuration, the I/O processing for the selected spare disk is suppressed.

[Operation S44] The firmware update of the selected spare disk is executed. In this processing, the maintenance control unit 125 transfers update firmware to the corresponding spare disk via the disk control unit 123, and writes the update firmware to the memory 202 of the corresponding spare disk. When the writing ends, the corresponding spare disk is restarted according to an instruction from the disk control unit 123, and the update firmware is applied. When the above processing is completed, processing in the next Operation S45 is executed.

[Operation S45] The maintenance control unit 125 requests the system monitoring unit 126 to release the suppression of monitoring of the operation state of the selected spare disk. With this configuration, monitoring of the operation state by the system monitoring unit 126 is restarted. Furthermore, the maintenance control unit 125 requests the disk control unit 123 to release the suppression of the I/O processing for the selected spare disk. With this configuration, the state where the I/O processing for the selected spare disk may be performed is restored.

[Operation S46] The maintenance control unit 125 determines whether there is a spare disk whose firmware has not been updated among the spare disks registered in the update order management table 113. In a case where there is a corresponding spare disk, the processing proceeds to Operation S41, and a spare disk whose firmware has not been updated is selected from the corresponding spare disks. On the other hand, in a case where there is no corresponding spare disk, the firmware update processing for the spare disk ends.

In the above processing in FIGS. 10 to 12, by adopting an appropriate update processing procedure according to use of a disk whose firmware is to be updated, efficiency of the update processing may be improved and a time needed for the processing may be shortened. For example, in a case where the processing in FIG. 10 and the processing in FIG. 11 are compared, there is the following difference in the processing procedure. In a normal state before the firmware update, the I/O processing is being performed for the disk drive of the disk cache. Thus, the update processing in FIG. 11 includes the processing for suppressing the I/O processing for the disk drive of the disk cache and the processing for releasing the suppression. On the other hand, in the normal state, the I/O processing is not performed for the unused disk. Thus, the update processing in FIG. 10 does not include the processing for suppressing the I/O processing for the unused disk and the processing for releasing the suppression.

Furthermore, in the processing in FIG. 12, in a case where there is a RAID data disk in an abnormal state among the RAID data disks included in the RAID group in which the disk to be updated serves as a spare destination, the firmware update for the disk to be updated is not executed. With this configuration, it is possible to reduce a probability of occurrence of a situation where a disk to be updated may not be incorporated into a RAID group when an existing RAID data disk fails.

Next, the firmware update processing for a RAID data disk will be described. As described above, at the time of the firmware update for a RAID data disk, control is performed so that the I/O processing is continued by using an unused disk or a spare disk. In the following description, the firmware update processing using an unused disk is referred to as “first update processing”, and the firmware update processing using a spare disk is referred to as “second update processing”.

In a case where firmware of a RAID data disk is updated, the first update processing and the second update processing are selectively executed according to a comparison result between an amount of write data in a disk to be updated in the most recent unit time and a predetermined threshold. The “amount of write data” includes a new data writing amount and an update data writing amount. In the present embodiment, the first update processing is executed in a case where the amount of the write data is less than the threshold, and the second update processing is executed in a case where the amount of the write data is equal to or greater than the threshold.

Furthermore, in the present embodiment, it is assumed that a “data write rate” is used as the amount of the write data to be compared with the threshold. The data write rate indicates a ratio of the amount of the write data in a unit time to storage capacity of the entire disk to be updated. Note that an absolute amount of the write data may be used as the amount of the write data to be compared with the threshold. Furthermore, in the present embodiment, it is assumed that the unit time is 1 minute.

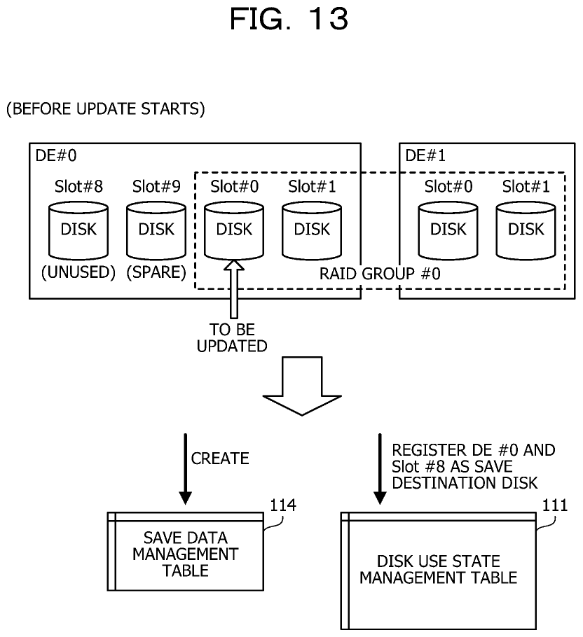

Here, first, the first update processing and related processing will be described with reference to FIGS. 13 to 16. FIG. 13 is a diagram for describing processing at a start of the first update processing. In FIG. 13, it is assumed that four disk drives with the DE #0 and the slots #0 and #1, and the DE #1 and the slots #0 and #1 are included in a RAID group #0. Furthermore, it is assumed that a disk drive with the DE #0 and the slot #8 is an unused disk, and a disk drive with the DE #0 and the slot #9 is set as a spare disk corresponding to the RAID group #0.

It is assumed that, from such a state, the disk drive with the DE #0 and the slot #0 is selected as a disk whose firmware is to be updated. Then, the maintenance control unit 125 suppresses I/O processing for the disk to be updated. At the same time, the maintenance control unit 125 registers the DE #0 and the slot #8 indicating an unused disk as the save destination disk and registers “saving” as the status in a record corresponding to the disk to be updated among the records of the disk use state management table 111. With this configuration, the disk drive with the DE #0 and the slot #8 is set as a save destination of write data. Moreover, the maintenance control unit 125 creates the save data management table 114 for managing data written to the save destination disk. After executing the above processing, the maintenance control unit 125 starts the firmware update of the disk to be updated.

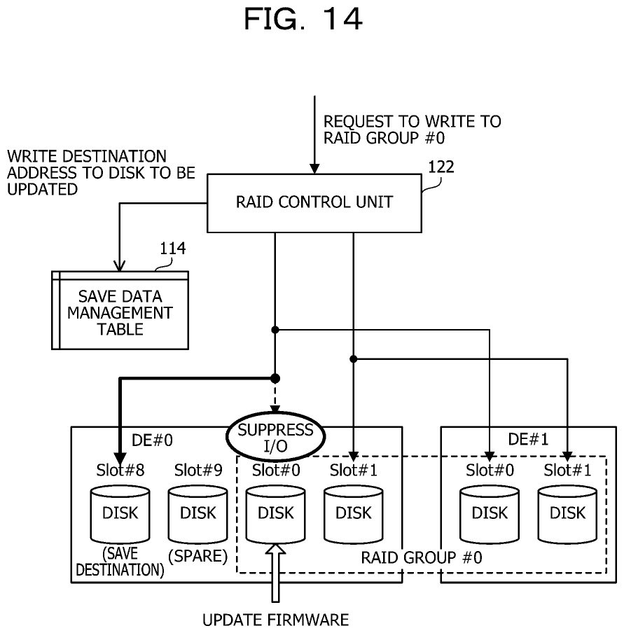

FIG. 14 is a diagram for describing write processing during the first update processing. It is assumed that, in the disk use state management table 111, data writing to the RAID group #0 is requested in a state where the save destination disk is set for the DE #0 and the slot #0 indicating the disk to be updated, and the status is “saving”.

In this state, the I/O processing for the disk to be updated is suppressed. In this case, the RAID control unit 122 writes write data to be written to the disk to be updated to the save destination disk. At the same time, the RAID control unit 122 registers a write destination address (save source address) of the write data to the original disk to be updated in the save data management table 114 in association with a write destination address (save destination address) in the save destination disk.

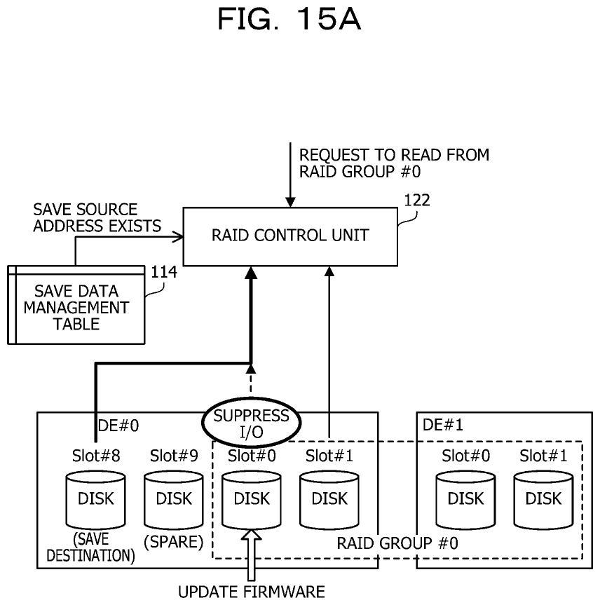

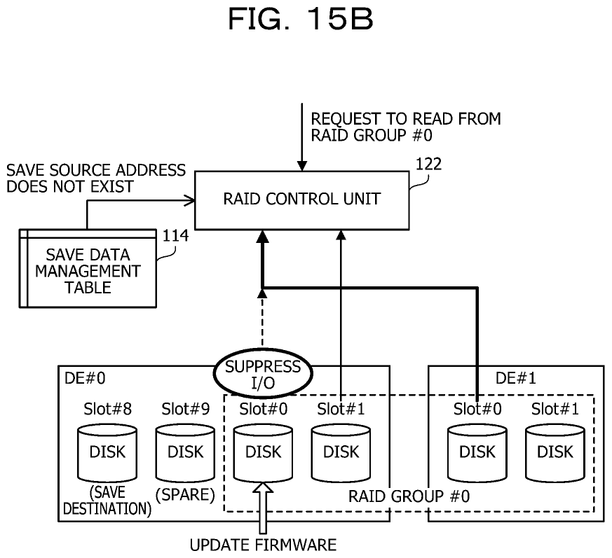

FIGS. 15A and 15B are diagrams for describing read processing during the first update processing. It is assumed that, in the disk use state management table 111, data reading from the RAID group #0 is requested in a state where the save destination disk is set for the DE #0 and the slot #0 indicating the disk to be updated, and the status is “saving”. Then, it is assumed that the RAID control unit 122 needs to read data from the disk to be updated in response to this read request. In this case, the RAID control unit 122 refers to the save data management table 114 and determines whether a read source address in the disk to be updated is registered in the save data management table 114 as a save source address.

FIG. 15A illustrates processing in a case where the corresponding save source address is registered in the save data management table 114, for example, in a case where the data requested to be read is stored in the save destination disk. In this case, the RAID control unit 122 acquires a save destination address associated with the corresponding save source address from the save data management table 114, and reads the data from the save destination address in the save destination disk.

On the other hand, FIG. 15B illustrates processing in a case where the corresponding save source address is not registered in the save data management table 114, for example, in a case where the data requested to be read is not stored in the save destination disk. In this case, the RAID control unit 122 acquires the data requested to be read by using data stored in remaining disk drives excluding the disk to be updated among the disk drives included in the RAID group #0.

In FIG. 15B, it is assumed that a RAID level of the RAID group #0 is “1+0”. Then, it is assumed that divided data obtained by dividing the write data is distributed and written to the disk drives with the DE #0 and the slots #0 and #1, and data of the disk drive with the DE #0 and the slot #0 is mirrored to the disk drive with the DE #1 and the slot #0, and data of the disk drive with the DE #0 and the slot #1 is mirrored to the disk drive with the DE #1 and the slot #1. In this case, the data requested to be read is read from the disk drive with the DE #1 and the slot #0 instead of the disk drive with the DE #0 and the slot #0 (drive to be updated).

Furthermore, for example, in a case where the RAID level of the RAID group #0 is “5”, the data requested to be read is restored on the basis of divided data and parity read from the remaining disk drives included in the RAID group #0.

As described above, in a case where the first update processing is executed, the I/O processing for the RAID group #0 may be continued even during a period when the firmware update for the disk to be updated is executed. Thus, it is possible to prevent a timeout for the I/O request from occurring before the firmware update is completed.

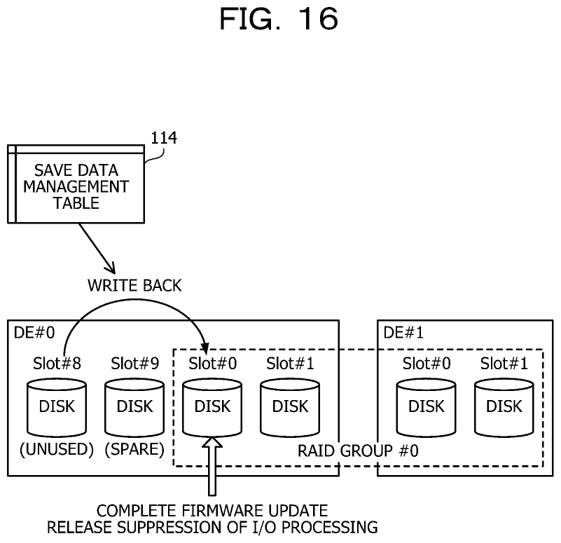

FIG. 16 is a diagram for describing writeback processing executed after the first update processing. When the firmware update for the disk to be updated is completed, the maintenance control unit 125 releases the suppression of the I/O processing for the save source disk (the disk drive with the DE #0 and the slot #0) whose firmware has been updated. At the same time, the maintenance control unit 125 updates the status associated with the DE #0 and the slot #0 in the disk use state management table 111 to “writing back”. Then, the maintenance control unit 125 refers to the save data management table 114 and writes the data written to the save destination disk back to the save source disk. In this writing back, a set of the save source address and the save destination address is acquired from the save data management table 114, and data is read from the save destination address of the save destination disk, and is written to the save source address of the save source disk. When the writing is completed, the set of the save source address and the save destination address is deleted from the save data management table 114.

Furthermore, the I/O processing for the save source disk from the RAID control unit 122 becomes possible even during execution of the writing back. For example, when writing to the save source disk occurs, write data is written to the save source disk. At this time, in a case where the write destination address is registered in the save data management table 114 as the save source address, the save source address and the corresponding save destination address are deleted from the save data management table 114.

Furthermore, for example, when reading from the save source disk occurs, the save data management table 114 is referred to. In a case where the read source address is registered in the save data management table 114 as the save source address, the save destination address associated with the save source address is acquired, and data is read from the save destination address of the save destination disk. On the other hand, in a case where the read source address is not registered in the save data management table 114 as the save source address, data is read from the save source disk.

In this way, even while the writeback processing is being executed, the I/O processing for the save source disk from the RAID control unit 122 is possible, and no timeout occurs for the I/O processing.

Note that, regarding management of the data written to the save destination disk, instead of using the save data management table 114 as described above, the save source address may be added to the data written to the save destination disk. Note that, by associating the save source address with the save destination address in the save data management table 114, retrieval processing for determining whether the read source address is registered as the save source address in the read processing may be efficiently executed.

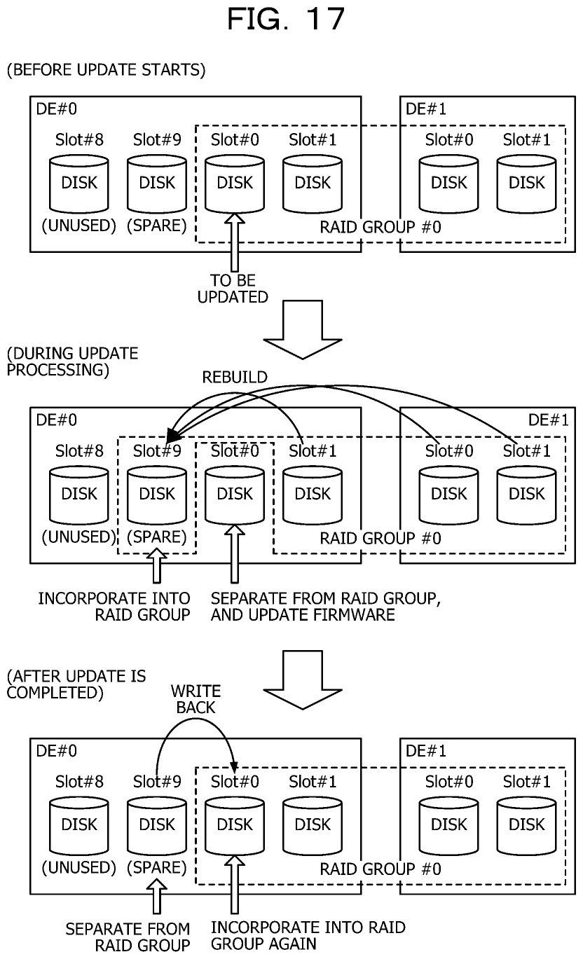

Next, FIG. 17 is a diagram for describing the second update processing. In an upper part of FIG. 17, as in FIG. 13 described above, it is assumed that four disk drives with the DE #0 and the slots #0 and #1, and the DE #1 and the slots #0 and #1 are included in a RAID group #0. Furthermore, it is assumed that a disk drive with the DE #0 and the slot #8 is an unused disk, and a disk drive with the DE #0 and the slot #9 is set as a spare disk corresponding to the RAID group #0.

Then, it is assumed that, from such a state, the disk drive with the DE #0 and the slot #0 is selected as a disk whose firmware is to be updated, as in FIG. 13. Then, as illustrated in a middle part of FIG. 17, the maintenance control unit 125 suppresses I/O processing for the disk to be updated. Furthermore, the maintenance control unit 125 requests the RAID control unit 122 to separate the disk to be updated from the RAID group #0 and incorporate the disk drive with the DE #0 and the slot #9 serving as a spare disk into the RAID group #0. Then, the maintenance control unit 125 starts the firmware update of the disk to be updated.

In the same procedure as a case where the disk to be updated fails, the RAID control unit 122 separates the disk to be updated from the RAID group #0, and incorporates the spare disk into the RAID group #0. At this time, in the disk use state management table 111, a RAID group number corresponding to the DE #0 and the slot #0 is temporarily deleted, and “0” is temporarily registered as a RAID group number corresponding to the DE #0 and the slot #9. Furthermore, use corresponding to the DE #0 and the slot #9 is temporarily changed to a RAID data disk.

After incorporating the spare disk into the RAID group #0, the RAID control unit 122 restores data of the separated disk to be updated by using data of remaining disk drives included in the RAID group #0, and writes the data to the spare disk. Furthermore, the RAID control unit 122 executes such rebuild processing while continuing the I/O processing for the RAID group #0.

When the firmware update for the disk to be updated is completed, as illustrated in a lower part of FIG. 17, the maintenance control unit 125 requests the RAID control unit 122 to separate the incorporated spare disk from the RAID group #0 and incorporate the disk to be updated into the RAID group #0 again. Then, the maintenance control unit 125 releases the suppression of the I/O processing for the disk to be updated.

The RAID control unit 122 writes the data stored in the separated spare disk back to the incorporated disk to be updated. The RAID control unit 122 executes such writeback processing while continuing the I/O processing for the RAID group #0. Furthermore, the RAID control unit 122 may also write only the data rebuilt on the spare disk while the firmware update of the disk to be updated is being executed, back to the incorporated disk to be updated.

As described above, in a case where the second update processing is executed, similarly to the execution of the first update processing, the I/O processing for the RAID group #0 may be continued even during a period when the firmware update for the disk to be updated is executed. Thus, it is possible to prevent a timeout for the I/O request from occurring before the firmware update is completed. Furthermore, since the I/O processing for the RAID group #0 continues even while the writeback processing is being executed after the firmware update, no timeout occurs for the I/O processing.

Here, comparing the first update processing and the second update processing, in a case where the second update processing is executed, a setting change for separating the disk to be updated from the RAID group and incorporating the spare disk into the RAID group is performed. Moreover, in the case where the second update processing is executed, the processing of rebuilding the data of the separated disk to be updated and writing the data to the incorporated spare disk is performed. Thus, the processing procedure is more complicated and a processing load is higher in the case where the second update processing is executed than in a case where the first update processing is executed. Therefore, it may be said that executing the first update processing as much as possible may improve efficiency of the entire processing related to the firmware update.

On the other hand, in the case where the first update processing is executed, the greater the amount of the write data to the disk to be updated during the firmware update processing, the greater the amount of the data to be written back to the original disk drive after the update ends. Thus, the greater the amount of the write data to the disk to be updated during the firmware update processing, the lower processing efficiency when the first update processing is executed. Therefore, it may be said that, by executing the first update processing in a case where it is estimated that the amount of the write data to the disk to be updated during the firmware update processing is small, efficiency of the entire processing related to the firmware update may be improved.

For such a reason, in the present embodiment, the first update processing is executed in a case where the data write rate in the most recent unit time is less than the threshold, and the second update processing is executed in a case where the data write rate in the most recent unit time is equal to or greater than the threshold. With this configuration, efficiency of the firmware update processing for a RAID data disk may be improved.

Next, the firmware update processing for a RAID data disk will be described by using a flowchart.

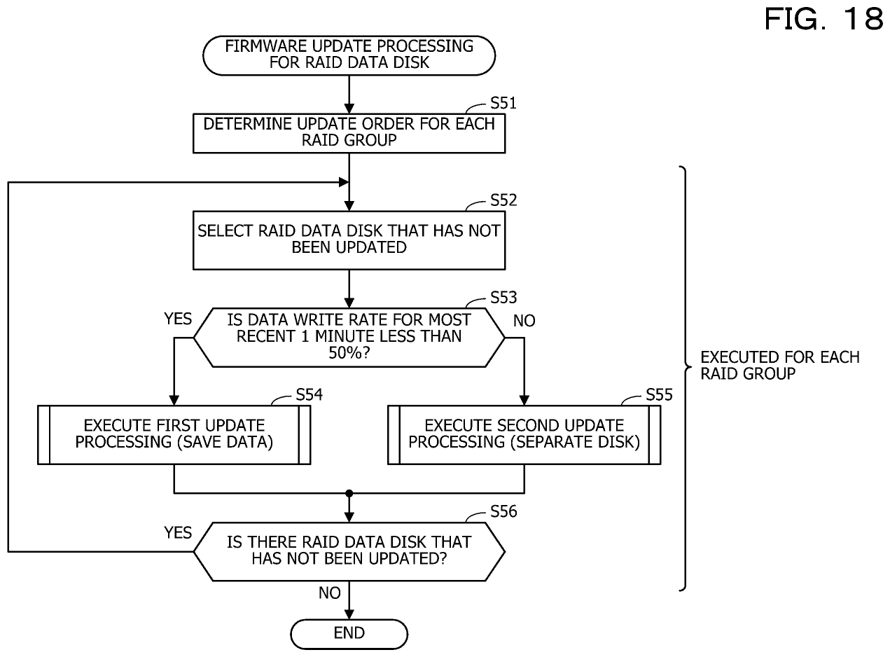

FIG. 18 is an example of a flowchart illustrating a procedure of the firmware update processing for a RAID data disk. The processing in FIG. 18 corresponds to the processing in Operation S16 in FIG. 8.

[Operation S51] For RAID data disks classified for each RAID group in the update order management table 113, the maintenance control unit 125 determines, for each RAID group, firmware update order of the RAID data disks included in each RAID group.

Processing of the subsequent Operations S52 to S56 is executed for each RAID group. Furthermore, the processing in Operations S52 to S56 for each RAID group may be executed in parallel.

[Operation S52] The maintenance control unit 125 selects, as a disk to be updated, a RAID data disk with the earliest update order from RAID data disks whose firmware have not been updated among the RAID data disks included in the RAID group to be processed.

[Operation S53] The maintenance control unit 125 acquires a data write rate for the most recent 1 minute in the selected disk to be updated from the system monitoring unit 126, and compares the acquired data write rate with a predetermined threshold. Here, as an example, the threshold is set to 50%. In a case where the data write rate is less than 50%, the processing proceeds to Operation S54, and in a case where the data write rate is equal to or greater than 50%, the processing proceeds to Operation S55.

[Operation S54] The first update processing is executed. In this processing, write data to the disk to be updated is saved to a save destination disk.

[Operation S55] The second update processing is executed. In this processing, the disk to be updated is separated from the RAID group, and a spare disk is incorporated into the RAID group.

[Operation S56] The maintenance control unit 125 determines whether there is a RAID data disk whose firmware has not been updated among the RAID data disks included in the RAID group to be processed. In a case where there is a corresponding RAID data disk, the processing proceeds to Operation S52, and a RAID data disk with the earliest update order is selected from the corresponding RAID data disks. On the other hand, in a case where there is no corresponding RAID data disk, the firmware update processing for the RAID data disk ends.

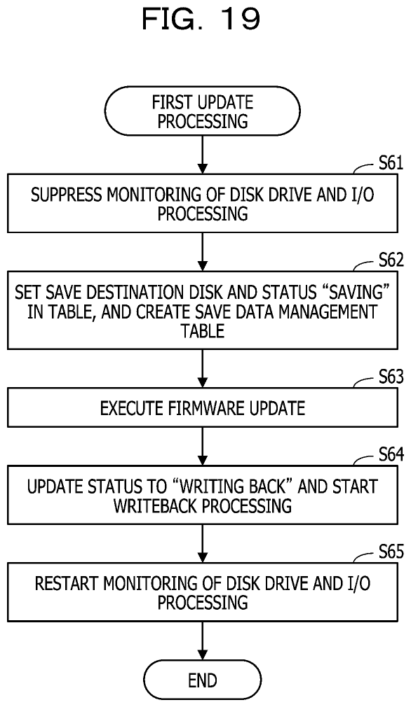

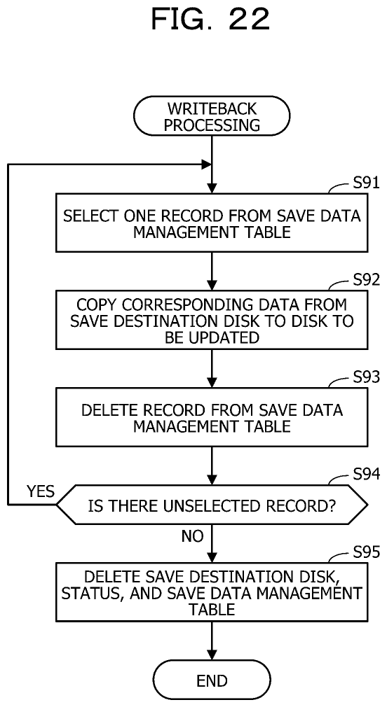

FIG. 19 is an example of a flowchart illustrating a procedure of the first update processing. The processing in FIG. 19 corresponds to the processing in Operation S54 in FIG. 18.

[Operation S61] The maintenance control unit 125 requests the system monitoring unit 126 to suppress monitoring of an operation state of the disk to be updated selected in Operation S52 in FIG. 18. With this configuration, monitoring of the operation state of the disk to be updated is suppressed. Furthermore, the maintenance control unit 125 requests the disk control unit 123 to suppress the I/O processing for the disk to be updated. With this configuration, the I/O processing for the disk to be updated is suppressed.

[Operation S62] The maintenance control unit 125 specifies a record of the disk to be updated from the disk use state management table 111. The maintenance control unit 125 sets an identification number of an unused disk serving as a save destination in the item of the save destination disk in the specified record, and sets “saving” in the item of the save processing status. Furthermore, the maintenance control unit 125 creates the save data management table 114.

[Operation S63] The firmware update of the disk to be updated is executed. In this processing, the maintenance control unit 125 transfers update firmware to the disk to be updated via the disk control unit 123, and writes the update firmware to the memory 202 of the disk to be updated. When the writing ends, the disk to be updated is restarted according to an instruction from the disk control unit 123, and the update firmware is applied. When the above processing is completed, processing in the next Operation S64 is executed.

[Operation S64] The maintenance control unit 125 updates the save processing status to “writing back” in the record specified in Operation S62. Then, the maintenance control unit 125 starts writeback processing from the save destination disk to the disk to be updated. Note that this writeback processing will be described later with reference to FIG. 22.

[Operation S65] The maintenance control unit 125 requests the system monitoring unit 126 to release the suppression of monitoring of the operation state of the disk to be updated. With this configuration, monitoring of the operation state by the system monitoring unit 126 is restarted. Furthermore, the maintenance control unit 125 requests the disk control unit 123 to release the suppression of the I/O processing for the disk to be updated. With this configuration, the state where the I/O processing for the disk to be updated may be performed is restored.

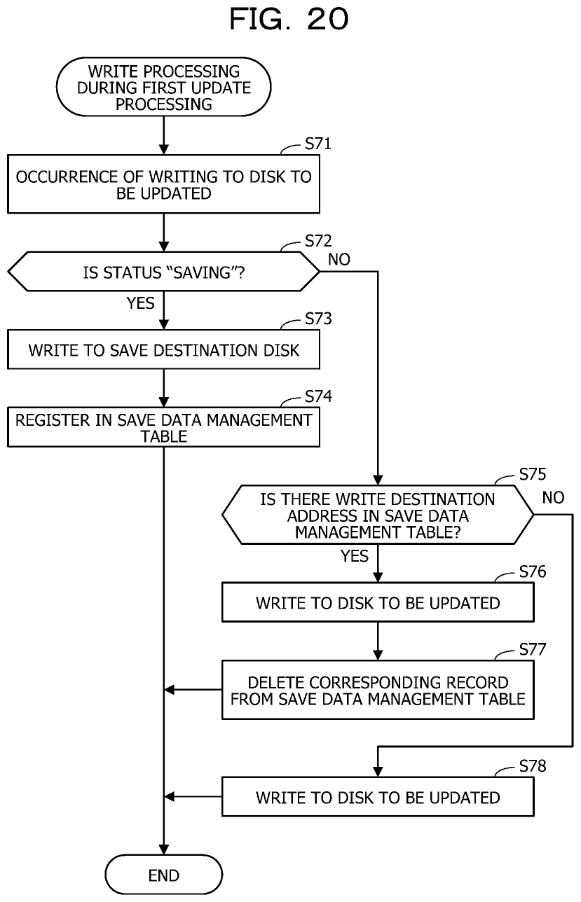

FIG. 20 is an example of a flowchart illustrating a procedure of the write processing during the first update processing.

[Operation S71] In the RAID control unit 122, when writing to the disk to be updated occurs in response to a write request to the RAID group to which the disk to be updated belongs, processing in the next Operation S72 and subsequent operations is executed.

[Operation S72] The RAID control unit 122 specifies a record of the disk to be updated serving as a write destination from the disk use state management table 111, and reads a setting value of the status. In a case where the status is “saving”, the processing proceeds to Operation S73, and in a case where the status is “writing back”, the processing proceeds to Operation S75.

[Operation S73] The RAID control unit 122 writes data to a save destination disk registered in the record specified in Operation S72.

[Operation S74] The RAID control unit 122 adds a new record to the save data management table 114. For the added record, the RAID control unit 122 registers, as a save source address, a write destination address for the disk to be updated, and registers, as a save destination address, a write destination address in the save destination disk in Operation S73.

Note that, in a case where there is a record in which the same write destination address for the disk to be updated is registered as the save source address in the save data management table 114, the RAID control unit 122 overwrites and registers, as the save destination address in the record, the write destination address in the save destination disk in Operation S73.

[Operation S75] The RAID control unit 122 determines whether there is a record in which a write destination address of data for the disk to be updated is registered as a save source address in the save data management table 114. In a case where there is a corresponding record, the processing proceeds to Operation S76, and in a case where there is no corresponding record, the processing proceeds to Operation S78.

[Operation S76] The RAID control unit 122 writes data to the disk to be updated (in this case, a RAID data disk whose firmware has been updated).

[Operation S77] The RAID control unit 122 deletes the record confirmed to exist in Operation S75 from the save data management table 114.

[Operation S78] The RAID control unit 122 writes data to the disk to be updated (in this case, a RAID data disk whose firmware has been updated).

With the above processing, data writing may be performed for the disk to be updated during the firmware update processing of the disk to be updated and during the writeback processing for the disk to be updated.

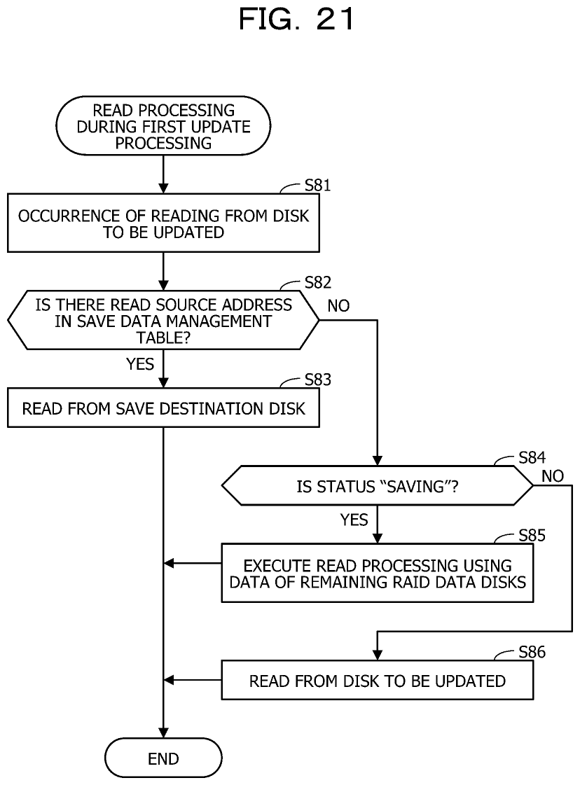

FIG. 21 is an example of a flowchart illustrating a procedure of the read processing during the first update processing.

[Operation S81] In the RAID control unit 122, when reading from the disk to be updated occurs in response to a read request from the RAID group to which the disk to be updated belongs, processing in the next Operation S82 and subsequent operations is executed.

[Operation S82] The RAID control unit 122 determines whether there is a record in which a read source address of data from the disk to be updated is registered as a save source address in the save data management table 114. In a case where there is a corresponding record, the processing proceeds to Operation S83, and in a case where there is no corresponding record, the processing proceeds to Operation S84.

[Operation S83] The RAID control unit 122 reads an identification number of a save destination disk and a save destination address from the record confirmed to exist in Operation S82. The RAID control unit 122 reads data from the save destination address in the save destination disk.

[Operation S84] The RAID control unit 122 specifies a record of the disk to be updated serving as a read source from the disk use state management table 111, and reads a setting value of the status. In a case where the status is “saving”, the processing proceeds to Operation S85, and in a case where the status is “writing back”, the processing proceeds to Operation S86.

[Operation S85] The RAID control unit 122 acquires read data to be read from the disk to be updated by using data of remaining RAID data disks excluding the disk to be updated among the RAID data disks included in the RAID group to which the disk to be updated belongs. For example, in a case where a RAID level of the RAID group is “1+0”, the RAID control unit 122 reads the read data from a RAID data disk in which data of the disk to be updated is mirrored among the remaining RAID data disks. Furthermore, for example, in a case where the RAID level of the RAID group is “5”, the RAID control unit 122 restores the read data by using divided data and parity read from the remaining RAID data disks.

[Operation S86] The RAID control unit 122 reads the read data from the disk to be updated (in this case, a RAID data disk whose firmware has been updated).

With the above processing, data reading may be performed from the disk to be updated during the firmware update processing of the disk to be updated and during the writeback processing for the disk to be updated.

FIG. 22 is an example of a flowchart illustrating a procedure of the writeback processing from the save destination disk to the disk to be updated. The processing in FIG. 22 is started in response to execution of Operation S64 in FIG. 19.

[Operation S91] The maintenance control unit 125 selects one record from the save data management table 114.

[Operation S92] The maintenance control unit 125 reads a save source address and a save destination address from the selected record. The maintenance control unit 125 reads data from a save destination address of the save destination disk, and copies the data to the save source address of the disk to be updated (in this case, a RAID data disk whose firmware has been updated).

[Operation S93] The maintenance control unit 125 deletes the selected record from the save data management table 114.

[Operation S94] The maintenance control unit 125 determines whether there is an unselected record in the save data management table 114. In a case where there is an unselected record, the processing proceeds to Operation S91, and the unselected record is selected. On the other hand, in a case where all records have been selected, the processing proceeds to Operation S95.

[Operation S95] The maintenance control unit 125 specifies a record corresponding to the disk to be updated from the disk use state management table 111. The maintenance control unit 125 deletes the identification number of the save destination disk and the setting value of the status (in this state, “writing back”) from the specified record. Furthermore, the maintenance control unit 125 deletes the save data management table 114.

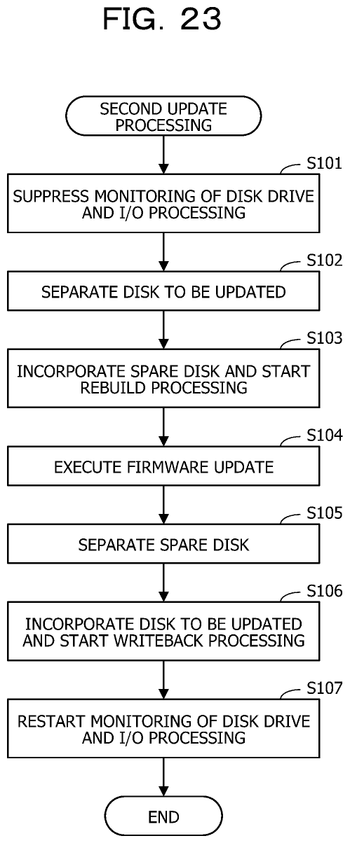

Next, FIG. 23 is an example of a flowchart illustrating a procedure of the second update processing. The processing in FIG. 23 corresponds to the processing in Operation S55 in FIG. 18.

[Operation S101] The maintenance control unit 125 requests the system monitoring unit 126 to suppress monitoring of an operation state of the disk to be updated selected in Operation S52 in FIG. 18. With this configuration, monitoring of the operation state of the disk to be updated is suppressed. Furthermore, the maintenance control unit 125 requests the disk control unit 123 to suppress the I/O processing for the disk to be updated. With this configuration, the I/O processing for the disk to be updated is suppressed.

[Operation S102] The maintenance control unit 125 separates the disk to be updated from the RAID group to which the disk to be updated currently belongs. For example, the maintenance control unit 125 specifies a record corresponding to the disk to be updated from the disk use state management table 111, and deletes a RAID group number registered in the specified record.

[Operation S103] The maintenance control unit 125 incorporates a spare disk allocated to the RAID group described above into this RAID group. For example, the maintenance control unit 125 specifies a record corresponding to the spare disk from the disk use state management table 111, and registers an identification number of the RAID group serving as an incorporation destination in the item of the RAID group number of the specified record.

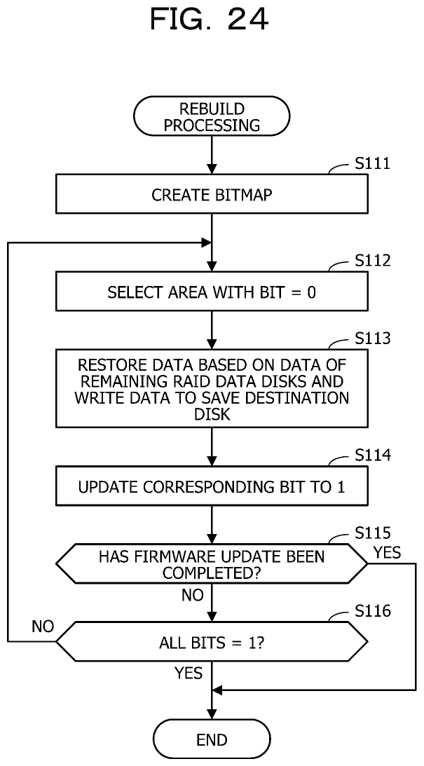

Then, the maintenance control unit 125 notifies the RAID control unit 122 of the incorporation of the spare disk, and requests execution of rebuild processing of data for the incorporated spare disk. With this configuration, the rebuild processing using data of remaining RAID data disks excluding the disk to be updated among the RAID data disks included in the RAID group is started by the RAID control unit 122. Note that this rebuild processing will be described later with reference to FIG. 24.

[Operation S104] The firmware update of the disk to be updated is executed. In this processing, the maintenance control unit 125 transfers update firmware to the disk to be updated via the disk control unit 123, and writes the update firmware to the memory 202 of the disk to be updated. When the writing ends, the disk to be updated is restarted according to an instruction from the disk control unit 123, and the update firmware is applied. When the above processing is completed, processing in the next Operation S105 is executed.

[Operation S105] The maintenance control unit 125 separates the spare disk from the RAID group. For example, the maintenance control unit 125 specifies the record corresponding to the spare disk from the disk use state management table 111, and deletes the RAID group number from the specified record.

[Operation S106] The maintenance control unit 125 incorporates the disk to be updated whose firmware has been updated into the RAID group. For example, the maintenance control unit 125 specifies the record corresponding to the disk to be updated from the disk use state management table 111, and registers the identification number of the RAID group serving as an incorporation destination in the item of the RAID group number of the specified record.

[Operation S107] The maintenance control unit 125 requests the system monitoring unit 126 to release the suppression of monitoring of the operation state of the disk to be updated. With this configuration, monitoring of the operation state by the system monitoring unit 126 is restarted. Furthermore, the maintenance control unit 125 requests the disk control unit 123 to release the suppression of the I/O processing for the disk to be updated. With this configuration, the state where the I/O processing for the disk to be updated may be performed is restored.

FIG. 24 is an example of a flowchart illustrating a procedure of the rebuild processing of data for the spare disk incorporated into the RAID group. The processing in FIG. 24 is started in response to execution of Operation S103 in FIG. 23.

[Operation S111] The RAID control unit 122 creates the rebuild management table 115. Here, as an example of the rebuild management table 115, it is assumed that a bitmap having a bit for each unit storage area of the disk to be updated is created. An initial value of each bit of the bitmap is set to “0”.

[Operation S112] The RAID control unit 122 selects a unit storage area with the bit value of “0” in the bitmap.

[Operation S113] The RAID control unit 122 restores data of the disk to be updated by using data of remaining RAID data disks excluding the separated disk to be updated among the RAID data disks included in the RAID group, and writes the data to the save destination disk.

For example, in a case where a RAID level of the RAID group is “1+0”, the RAID control unit 122 reads data stored in the selected unit storage area from a RAID data disk in which the data of the disk to be updated is mirrored among the remaining RAID data disks. The RAID control unit 122 writes the read data as it is to the selected unit storage area in the spare disk.

Furthermore, for example, in a case where the RAID level of the RAID group is “5”, the RAID control unit 122 reads data (divided data or parity) from the selected unit storage area in the remaining RAID data disks. On the basis of the read data, the RAID control unit 122 restores the data of the selected unit storage area in the disk to be updated, and writes the restored data to the selected unit storage area in the spare disk.

[Operation S114] The RAID control unit 122 updates the value of the bit corresponding to the unit storage area selected in Operation S112 to “1”, among the bits of the bitmap.

[Operation S115] The RAID control unit 122 inquires of the maintenance control unit 125 whether the firmware update processing in the disk to be updated has been completed. In a case where the firmware update processing has not been completed, the processing proceeds to Operation S116, and a unit storage area with the bit value of “0” is selected. On the other hand, in a case where the firmware update processing has been completed, the rebuild processing ends.

[Operation S116] The RAID control unit 122 determines whether a value of all the bits of the bitmap is “1”. In a case where there is even one bit with the bit value of “0”, the processing proceeds to Operation S112, and a unit storage area with the bit value of “0” is selected. On the other hand, in a case where the value of all the bits is “1”, the rebuild processing ends.

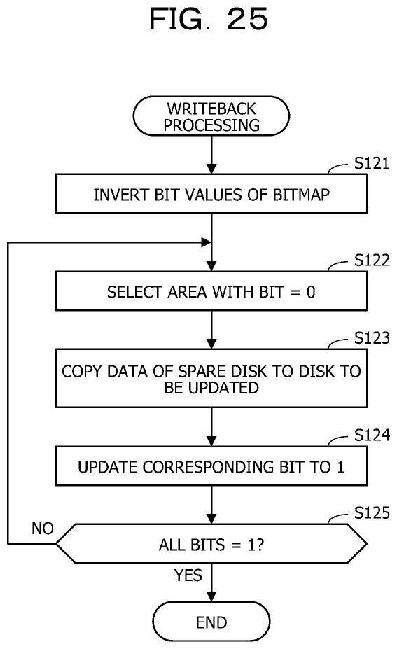

FIG. 25 is an example of a flowchart illustrating a procedure of the writeback processing from the spare disk to the disk to be updated. The processing in FIG. 25 is started in response to execution of Operation S106 in FIG. 23.

[Operation S121] The RAID control unit 122 inverts a value of each bit of the bitmap. With this configuration, the value of the bits corresponding to the unit storage area in which data has been rebuilt by the processing in FIG. 24 becomes “0”, and a value of other bits becomes “1”.

[Operation S122] The RAID control unit 122 selects the unit storage area with the bit value of “0” in the bitmap.

[Operation S123] The RAID control unit 122 reads data stored in the selected unit storage area from the spare disk, and copies the read data to the selected unit storage area in the disk to be updated.

[Operation S124] The RAID control unit 122 updates the value of the bit corresponding to the unit storage area selected in Operation S122 to “1”, among the bits of the bitmap.

[Operation S125] The RAID control unit 122 determines whether a value of all the bits of the bitmap is “1”. In a case where there is even one bit with the bit value of “0”, the processing proceeds to Operation S122, and a unit storage area with the bit value of “0” is selected. On the other hand, in a case where the value of all the bits is “1”, the writeback processing ends.

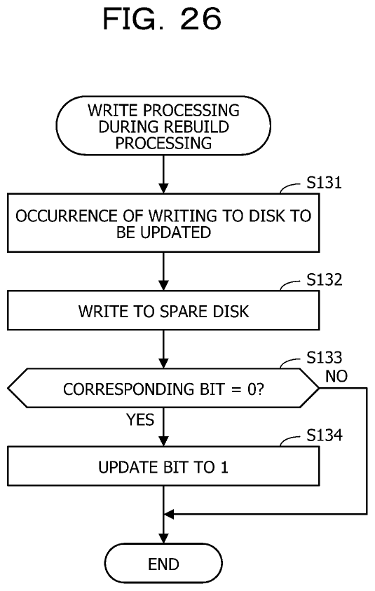

FIG. 26 is an example of a flowchart illustrating a procedure of the write processing during the rebuild processing.

[Operation S131] In the RAID control unit 122, when writing to the disk to be updated occurs in response to a write request to the RAID group to which the disk to be updated belongs, processing in the next Operation S132 and subsequent operations is executed.

[Operation S132] The RAID control unit 122 writes write data to the spare disk incorporated into the RAID group.

[Operation S133] The RAID control unit 122 reads a value of a bit corresponding to a unit storage area serving as a write destination among the bits of the bitmap. In a case where the bit value is “0”, the processing proceeds to Operation S134. On the other hand, in a case where the bit value is “1”, the processing in Operation S134 is skipped, and the write processing ends.

[Operation S134] The RAID control unit 122 updates the value of the bit which has been read in Operation S133 to “1”. Note that, in a case where writing as in Operation S131 occurs during the writeback processing in FIG. 25, the data is written to the disk to be updated that has been incorporated into the RAID group again. Furthermore, at this time, in a case where the value of the bit corresponding to the unit storage area serving as the write destination is “0”, this bit value is updated to “1”.

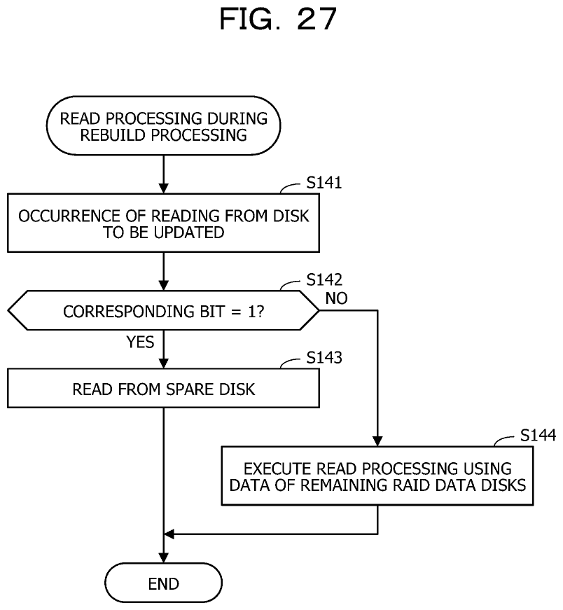

FIG. 27 is an example of a flowchart illustrating a procedure of the read processing during the rebuild processing.

[Operation S141] In the RAID control unit 122, when reading from the disk to be updated occurs in response to a read request from the RAID group to which the disk to be updated belongs, processing in the next Operation S142 and subsequent operations is executed.

[Operation S142] The RAID control unit 122 reads a value of a bit corresponding to a unit storage area serving as a read source among the bits of the bitmap. In a case where the bit value is “1”, the processing proceeds to Operation S143, and in a case where the bit value is “0”, the processing proceeds to Operation S144.

[Operation S143] The RAID control unit 122 reads data from the spare disk incorporated into the RAID group.

[Operation S144] The RAID control unit 122 acquires read data to be read from the disk to be updated by using data of remaining RAID data disks excluding the disk to be updated among the RAID data disks included in the RAID group to which the disk to be updated belongs. For example, in a case where a RAID level of the RAID group is “1+0”, the RAID control unit 122 reads the read data from a RAID data disk in which data of the disk to be updated is mirrored among the remaining RAID data disks. Furthermore, for example, in a case where the RAID level of the RAID group is “5”, the RAID control unit 122 restores the read data by using divided data and parity read from the remaining RAID data disks.

Note that, in a case where reading as in Operation S141 occurs during the writeback processing in FIG. 25, the following processing is executed according to the value of the corresponding bit. In a case where the bit value is “0”, the data is read from the spare disk separated from the RAID group. In a case where the bit value is “1”, the data is read from the disk to be updated that has been incorporated into the RAID group again.

Note that the processing functions of the devices (for example, the storage apparatus 1 or the control unit 2, the CMs 100a, 100b, 100c, and 100d, and the host devices 20a, 20b, 20c, . . . ) indicated in each of the embodiments described above may be implemented by a computer. In that case, a program describing the processing content of the functions to be held by each device is provided, and the processing functions described above are implemented on the computer by execution of the program on the computer. The program describing the processing content may be recorded on a computer-readable recording medium. The computer-readable recording medium includes a magnetic storage device, an optical disc, a semiconductor memory, and the like. The magnetic storage device includes a hard disk drive (HDD), a magnetic tape, and the like. The optical disc includes a compact disc (CD), a digital versatile disc (DVD), a Blu-ray disc (BD, registered trademark), and the like.

In a case where the program is to be distributed, for example, portable recording media such as DVDs and CDs in which the program is recorded are sold. Furthermore, it is also possible to store the program in a storage device of a server computer, and transfer the program from the server computer to another computer via a network.

The computer that executes the program stores, for example, the program recorded on the portable recording medium or the program transferred from the server computer in its own storage device. Then, the computer reads the program from its own storage device, and executes processing according to the program. Note that the computer may read the program directly from the portable recording medium, and execute processing according to the program. Furthermore, the computer may sequentially execute processing according to the received program each time when the program is transferred from the server computer connected via the network.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage apparatus comprising:
a memory; and
a processor coupled to the memory and configured to:
when writing of first data for a first storage device among two or more storage devices included in a redundant array of inexpensive disks (RAID) group among a plurality of storage devices is requested during update of firmware of the first storage device,
execute first write processing of
writing the first data for a second storage device other than the two or more storage devices among the plurality of storage devices, and
registering a write destination address of the first data in management information as a save source address in association with the first data; and
when reading of second data from the first storage device is requested during the update of the firmware,
execute first read processing of
referring to the management information,
reading the second data from the second storage device in a case where a read source address of the second data in the first storage device is registered in the management information as the save source address, based on a result of the referring, and
acquiring the second data based on data stored in another storage device other than the first storage device among the two or more storage devices in a case where the read source address of the second data is not registered in the management information as the save source address, based on the result of the referring.

2. The storage apparatus according to claim 1, wherein the processor is further configured to:
compare an amount of data written to the first storage device in a most recent unit time with a predetermined amount at a start of the update of the firmware,
in a case where the amount of the data written is equal to or greater than the predetermined amount,
separate the first storage device from the RAID group,
incorporate a third storage device other than the two or more storage devices and the second storage device among the plurality of storage devices into the RAID group,
start the update of the firmware, during the update of the firmware,
rebuild data stored in the first storage device, based on the data stored in the another storage device, and store the rebuild data in the third storage device,
execute, when writing of third data to the first storage device is requested, second writing processing of writing the third data to the third storage device, and
execute, when reading of fourth data from the first storage device is requested, second reading processing of restoring the fourth data, based on the data stored in the another storage device, and
in a case where the amount of the data written is less than the predetermined amount,
set the second storage device as a save destination of data requested to be written,
start the update of the firmware, during the update of the firmware,
execute the first write processing when writing of the first data to the first storage device is requested, and
execute the first read processing when reading of the second data from the first storage device is requested.

3. The storage apparatus according to claim 1, wherein the processor is further configured to:
when the update of the firmware is completed,
write data written to the second storage device back to the first storage device, based on the management information, and delete the save source address corresponding to the data written back to the first storage device from the management information,
when writing of fifth data to the first storage device is requested during execution of the writing back,
write the fifth data to the first storage device,
in a case where a write destination address of the fifth data in the first storage device is registered in the management information as the save source address,
delete the save source address that indicates the write destination address of the fifth data from the management information, and
when reading of sixth data from the first storage device is requested during execution of the writing back,
refer to the management information,
in a case where a read source address of the sixth data in the first storage device is registered in the management information as the save source address,
read the sixth data from the second storage device,
in a case where the read source address of the sixth data is not registered in the management information as the save source address,
read the sixth data from the first storage device.

4. A control method for causing a computer to control access to a plurality of storage devices, the control method comprising:
when writing of first data for a first storage device among two or more storage devices included in a redundant array of inexpensive disks (RAID) group among the plurality of storage devices is requested during update of firmware of the first storage device, executing first write processing of
writing the first data for a second storage device other than the two or more storage devices among the plurality of storage devices, and
registering a write destination address of the first data in management information as a save source address in association with the first data; and
when reading of second data from the first storage device is requested during the update of the firmware,
executing first read processing of
referring to the management information,
reading the second data from the second storage device in a case where a read source address of the second data in the first storage device is registered in the management information as the save source address, based on a result of the referring, and
acquiring the second data based on data stored in another storage device other than the first storage device among the two or more storage devices in a case where the read source address of the second data is not registered in the management information as the save source address, based on the result of the referring.
